(19) United States
(12) Patent Application Publication
(10) Pub. No.: US 2024/0386468 A1
(43) Pub. Date: Nov. 21, 2024

(54) APPARATUS AND METHODS FOR CUSTOMIZABLE LOW WEIGHT FLYER BOOKLETS

(71) Applicant: TRANSCONTINENTAL MEDIA G.P., Montreal (CA)

(72) Inventors: Philippe BERGERON, Montreal (CA); Alexandre PAGE-CUSSON, Montreal (CA); Mathieu DAGNAULT, Montreal (CA); André SEVIGNY, Montreal (CA); Julie CAVIOLA, Montreal (CA); Francis BOUCHER, Montreal (CA); Sébastien MAI, Montreal (CA); Marie-Claude BEAUCHAMP, Montreal (CA); Nancy BERGERON, Montreal (CA); Yves BÉDARD, Montreal (CA); Éric LABRECQUE, Montreal (CA)

(21) Appl. No.: 18/663,751

(22) Filed: May 14, 2024

Related U.S. Application Data
(60) Provisional application No. 63/502,242, filed on May 15, 2023.

(51) Int. Cl. G06Q 30/0241

(52) U.S. Cl. CPC G06Q 30/0276

(57) ABSTRACT

An admail advertising system comprising content from several advertisers, comprising stacked sheets of printing substrate with fold lines and configured to fold along the lines, and printed indicia on the sheets, the indicia corresponding to one or more content blocks, each content block being associated with one advertiser, weighing 150 grams or less and, when folded, meeting desired delivery standards. A method of producing and digitally integrating an advertising booklet, comprising a plurality of advertising contents from a plurality of advertisers, comprising providing to advertisers information respecting availability of one or more content blocks being associated with a predetermined publication date, receiving from advertising contents and an indication corresponding to at least one of the content blocks, responsive to the indications imposing the advertising contents on the content blocks, printing the advertising booklet comprising the content blocks and folding the advertising booklet to a size conforming to desired delivery standards.

### CROSS REFERENCE TO RELATED APPLICATIONS

The present application claims priority from U.S. Provisional Patent Application Ser. No. 63/502,242 filed on May 15, 2023 and herein incorporated by reference in its entirety.

### TECHNICAL FIELD

The present disclosure relates to printing, more specifically to printed products, even more specifically to improved printed products for advertising and digital implementations thereof.

### BACKGROUND OF THE ART

Advertising comprises numerous forms of communication, including flyer advertising, broadcast advertising, direct mail and digital advertising.

Flyer-based advertising, leaflets and other paper-based promotional material may take a variety of forms designed to attract and retain consumer attention or to improve consumer engagement. Japanese patent JP 2835428 describes promotional materials comprising a calendar. U.S. Pat. No. 6,520,542 describes a promotional mailable card with detachable coupons. U.S. Pat. No. 4,957,311 discloses a promotional card comprising a detachable index card and coupons, or a detachable index card and a postage-paid card for the consumer to send back.

Current paper-based advertising distribution methods and systems, such as admail and flyer distribution present several disadvantages. Businesses may incur multiple instances of design and production costs with little opportunity for economies of scale. Consumers may be bombarded with advertising materials several times per week, contributing to clutter and reducing consumer engagement with the material. Mail carriers and other distribution personnel may contend with multiple flyers from different advertisers, often in different formats, slowing down service.

Current methods and systems for advertising distribution also have a heightened environmental impact. The multiplicity of formats contributes to overuse of paper and plastic resources. Multiple production and printing processes consume unnecessary energy, and inefficient distribution contributes to excessive carbon emissions, for example by distribution personnel's vehicles.

There is accordingly an ongoing need for more cost- and resource-efficient advertising production and distribution methods and systems. There is also a need for environmentally friendly promotional material distribution systems and methods. There is also a need for advertising systems and methods that improve the consumer experience and drive better return on investment for advertisers.

### SUMMARY

According to a broad aspect of the present disclosure, an admail advertising system is provided, comprising content from a plurality of advertisers, comprising a plurality of stacked sheets of printing substrate, the sheets of printing substrate comprising one or more fold lines and being configured to fold along the fold lines, and further comprising printed indicia on the one or more sheets, the printed indicia corresponding to one or more content blocks, each content block being associated with one advertiser, the system weighing 200 grams or less and, when folded, meeting Canada Post Neighborhood Mail delivery standards.

In embodiments, the system is configured to be folded in quarters. In embodiments, at least one of the plurality of advertisers is selected from the group consisting of grocery stores, drugstores, department stores, furniture stores, home improvement stores and electronics stores. In embodiments, the system weighs 200 grams or less with some embodiments at 108 grams, 115 grams, and 128 grams depending upon mailing requirement.

In embodiments, the system is an unaddressed admail system thereby enabling generalized distribution. In other certain embodiments, the system is an addressed admail system for specified and predetermined distribution.

According to another broad aspect of the present disclosure, a method of producing an advertising booklet compatible with letter carrier delivery is provided, the booklet comprising a plurality of advertising contents from a plurality of advertisers, the method comprising providing, to the plurality of advertisers, information respecting an availability of one or more content blocks, each of the one or more content blocks being associated with a predetermined publication date, each predetermined publication date having a predetermined quantity of content blocks available; receiving, from two or more of the plurality of advertisers, from each advertiser, at least one of the plurality of advertising contents, and, from each advertiser, an indication corresponding to at least one of the plurality of the content blocks; responsive to the indications received from the plurality of advertisers, imposing the advertising contents on content blocks associated with the predetermined publication date; printing the advertising booklet comprising the content blocks so imposed; and folding the advertising booklet to a size conforming to Canada Post Neighborhood Mail delivery standards.

In embodiments, the availability of the one or more content blocks for each of the plurality of advertisers is capped at a predetermined number.

In embodiments, each of the one or more content blocks is further associated with a geographic area. In embodiments, the geographic area is a municipality. In embodiments, the geographic area is a postcode or related segments thereof including the forward sortation area (FSA). In embodiments, the geographic area is a letter carrier walk.

In embodiments, the method comprises providing the content blocks comprising the advertising contents to a user device. In embodiments, the method comprises receiving additional advertising contents from the plurality of advertisers and providing the additional advertising contents to the user device.

According to another broad aspect of the present disclosure, an advertising production management system is provided, comprising a processor, a non-transitory storage medium operatively connected to the processor, the non-transitory storage medium comprising computer-readable instructions, the processor, upon executing the computer-readable instructions, being configured for: providing to a plurality of advertisers information respecting an availability of one or more content blocks, each of the one or more content blocks being associated with a predetermined publication date, each predetermined publication date having a predetermined quantity of content blocks available; receiving, from two or more of the plurality of advertisers: from each advertiser, at least one advertising content; and from each advertiser, an indication corresponding to at least one of the plurality of the content blocks; responsive to the indications received from the plurality of advertisers, imposing the advertising contents on content blocks associated with the predetermined publication date; and generating and outputting one of: a soft proof for an advertising booklet comprising the content blocks associated with the predetermined publication date; a print-related command associated with the content blocks associated with the predetermined publication date; and digital output data that, when received at a user device, cause the user device to display the content blocks associated with the predetermined publication date.

According to another broad aspect of the present disclosure, an advertising production management system is provided that includes a processor and a non-transitory storage medium operatively connected to the processor and including computer-readable instructions, the system, upon the processor executing the computer-readable instructions, comprising: a booking system for generating an order from a client, the order including client advertising data and zone preference collection; a media generation mechanism for providing print media corresponding to client advertising; an automated software engine for correlating client advertising data and zone preferences received from the client and at least one additional client to produce a digital output corresponding to an advertising booklet; and a production facility for printing and folding a physical embodiment of the advertising booklet.

In embodiments, the system comprises includes wherein the media generation mechanism includes large scale media generation.

In embodiments, the system comprises includes wherein the media generation mechanism includes local prepress design.

In embodiments, the system comprises includes wherein the booking system includes a graphical user interface for client selection of zone preferences corresponding to client advertising markets.

In embodiments, the system comprises includes wherein the physical embodiment of the advertising booklet includes advertisements of the client and the at least one additional client and is sized and dimensioned in a folded state to adhere to postal mailing constraints.

### BRIEF DESCRIPTION OF THE DRAWINGS

Reference will now be made to the accompanying drawings, showing by way of illustration exemplary embodiments of the present disclosure.

FIG. 1A is a representation of an exemplary advertising system according to the present disclosure in a folded state. FIG. 1B is a representation of an exemplary advertising system according to the present disclosure in an unfolded state.

FIG. 2 is a schematic diagram of a method for producing an advertising booklet according to an embodiment of the present disclosure.

FIG. 3 is a representation of an exemplary advertising production management system according to an embodiment of the present disclosure.

FIG. 4 is a representation of an exemplary workflow for implementing systems and methods according to the present disclosure.

FIG. 5 and FIG. 6 are representations of an exemplary web interface showing zone selection in accordance with the present disclosure.

### DETAILED DESCRIPTION

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that where the claims or disclosure refer to “a” or “an” element, such reference is not to be construed that there is only one of that element. It is to be understood that where the disclosure states that a component, feature, structure, or characteristic “may”, “might”, “can” or “could” be included, that particular component, feature, structure, or characteristic is not required to be included.

In the context of the present disclosure, the expression “about” is to be understood as referring to a reasonable range of deviation from the stated value such that the result or the principle of operation are not substantially affected, for example a reasonable deviation of 5% or 10%, so long as such deviation does not negate the term it modifies or unless the context dictates otherwise to a skilled person.

In the context of the present disclosure, a “server” is a computer program that is running on appropriate hardware and can receive requests (e.g., from electronic devices) over a network (e.g., a communication network), and conducting those requests, or causing those requests to be conducted. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present disclosure, “user device” is any apparatus or hardware that can run software appropriate to the relevant task at hand. Thus, some (non-limiting) examples of user devices include general purpose personal computers (desktops, laptops, netbooks, etc.), mobile computing devices, smartphones, and tablets. The use of the expression “a user device” does not preclude multiple devices being used in receiving/sending, conducting or causing to be conducted any task or request, or the consequences of any task or request, or steps of any method described herein.

In the context of the present disclosure, the expression “computer readable storage medium” (also referred to as “storage medium”, “memory” and “storage”) is intended to include non-transitory media of any nature and kind whatsoever, including without limitation RAM, ROM, disks (CD-ROMs, DVDs, floppy disks, hard drivers, etc.), USB keys, solid-state drives, tape drives, etc. A plurality of components may be combined to form the computer information storage media, including two or more media components of a same type and/or two or more media components of diverse types.

In the context of the present disclosure, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present disclosure, the expression “information” includes information of any nature or kind whatsoever capable of being stored in a database. This information includes, but is not limited to audiovisual works (images, movies, sound records, presentations etc.), data (location data, numerical data, user credentials, user preferences, etc.), text (opinions, comments, questions, messages, etc.), documents, spreadsheets, lists of words, etc.

In the context of the present disclosure, unless expressly provided otherwise, an “indication” is a signal or any nature carrying information required to convey an instruction, a response or a preference to another device.

In the context of the present disclosure, the expression “communication network” or “network” is intended to include a telecommunications network such as a computer network, the Internet, a telephone network, a Telex network, a TCP/IP data network (e.g., a WAN network, a LAN network, etc.), and the like. The term “network” includes a wired network or direct-wired connection, and wireless media such as acoustic, radio frequency (RF), infrared and other wireless media, as well as combinations of any of the above.

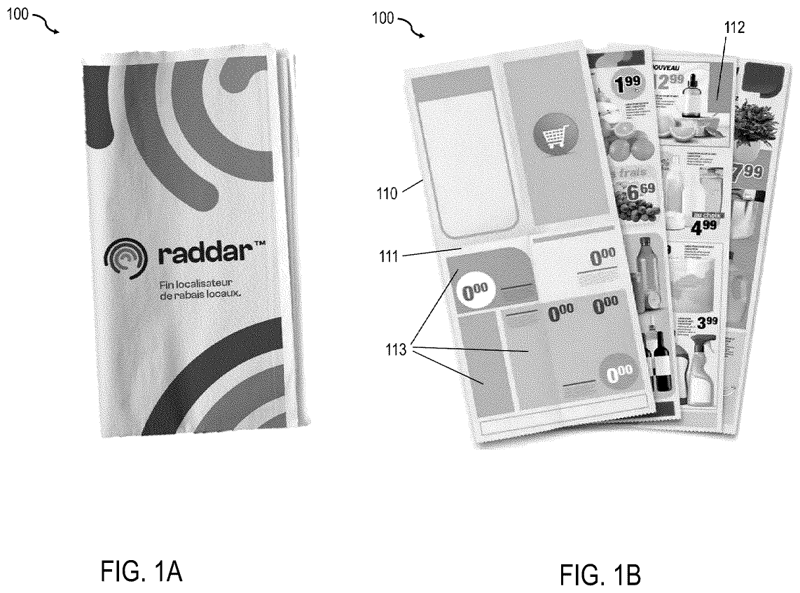

The present disclosure provides a printed product comprising a plurality of advertising contents from a plurality of advertisers. Referring to FIG. 1, an exemplary printed product such as an admail advertising system 100 according to the present disclosure is presented. The system 100 comprises one or more sheets 110 of printing substrate, for example sheets of paper or of another appropriate substrate on which content may be printed.

The sheets 110 may comprise one or more fold lines 111 and may be configured to be folded along fold lines 111. The sheets 110 further comprise printed indicia 112. The printed indicia 112 may be advertisements, promotional announcements, coupons or other promotional content intended for distribution to a wide audience. Advertisers may provide images, text, graphical elements or other data suitable for producing the printed indicia 112 for the purpose of integrating the elements corresponding to the data into a printed product, such as the system 100.

Advertisers providing the data for the system 100 may comprise grocery stores, drugstores, department stores, furniture stores, home improvement stores and electronics stores. It will be understood that other advertisers may also provide data for use in the system 100, such as general stores, professionals, tradespeople, healthcare providers, political candidates, real estate brokers, car dealers, local merchants, and others.

The steps of producing the printed product may be automated.

The sheets 110 may comprise content blocks 113. Each content block 113 may be associated with at least a portion of a sheet 110, for example with a full sheet 110, a half-sheet, a quarter, an eighth, a sixteenth, or any other suitable portion of a sheet 110. Each printed indicia 112 is associated with a content block 113. Advertisers may provide data with respect to the printed indicia 112 in each content block 113. Advertisers may also provide the data associated to a plurality of content blocks 113, without specifying a particular content block 113. For example, an advertiser may reserve or purchase a plurality of content blocks 113 and provide data for printing printed indicia 112 in any of the plurality of content blocks 113, or to repeat some or all of the indicia 112 in the plurality of content blocks 113.

Each content block 113 may be associated with one advertiser. Accordingly, each advertiser may provide data associated with printed indicia 112, the data being adapted to the size, position and other characteristics of content block 113. The characteristics of content block 113 may be preset, such as size, positioning on the sheets 110, color palette, margins, bleed, and other characteristics apparent to ordinarily skilled persons. Accordingly, an advertiser may adapt the data associated with printed indicia 112 based on the characteristics of content block 113. The advertiser thus has increased flexibility with respect to the advertising content to be distributed using the system 100.

The system 100 is adapted for letter carriers' convenience and to meet applicable mail distribution standards. Mail distribution standards, such as admail delivery standards, prescribe acceptable ranges such as size ranges, weight ranges and other characteristics of the mail pieces for distribution. The system 100 may be configured to be distributed in a folded state, for example folded into quarters, having a folded size appropriate for delivery through a letterbox, to a community mailbox or through other acceptable means of admail delivery. The system 100 may also be configured to have a predetermined weight within an acceptable range, for example between 20 and 500 grams, for example between 50 and 300 grams, for example between 100 and 200 grams, for example 150 grams.

Production of the system 100 may be adapted to meeting mail delivery standards. For example, the total quantity of sheets 110 in the system 100 may be limited, such that the total weight of the system 100 in the folded state does not exceed a predetermined weight, for example the system does not exceed a weight of 150 grams, or of 100 grams. It will be understood that the predetermined weight may be adapted for local mail delivery standards. The total number of content blocks 113 may also be limited.

The system 100 may be implemented as an unaddressed admail system. In such an implementation, one or more content blocks 113 that remain visible in the folded state of system 100 may comprise advertising material, for example printed indicia 112 corresponding to an advertisement. The content blocks 113 visible in the folded state may comprise different printed indicia 112, for example printed indicia 112 corresponding to a brand, a trademark, or to other indications of an entity having produced the system 100. For example, the system 100 may be produced by an entity receiving data from a plurality of advertisers and aggregating said data into the system 100 for further distribution to a wide audience. Said entity may place printed indicia corresponding to its name, its logo, or a branding for the system 100 in the content block 113 visible when the system 100 is in a folded state.

The system 100 may be implemented as an addressed admail or unaddressed admail system. In such an addressed implementation, at least one of the content blocks 113 visible when the system 100 is in a folded state may comprise an address of a recipient for whom the system 100 is intended. It will be understood that the address need not be a complete address, such as an address comprising a name. For example, the system 100 may be addressed to “The Occupant”, “The Resident”, or in another appropriate manner. Other means of addressing addressed admail are within the scope of this disclosure. In more typical embodiments, the system 100 would not be addressed. Rather, the system 100 would be produced without an addressee and for generalized distribution as is well known in some mailstreams such as within Canada Post.

The one or more content blocks 113 visible when the system 100 is in a folded state may further comprise other indicia useful for implementing the system 100, such as indicia corresponding to postage, sender, contract numbers, campaign numbers, barcodes, and others.

The sheets 110 may be of a suitable size for achieving the folded size of the system 100. For example, the sheets 110 may be of an appropriate size between about 8″ by 21″ and about 12″ by 23″, for example 11.25″ by 22″, for example 11.25″ by 11″.

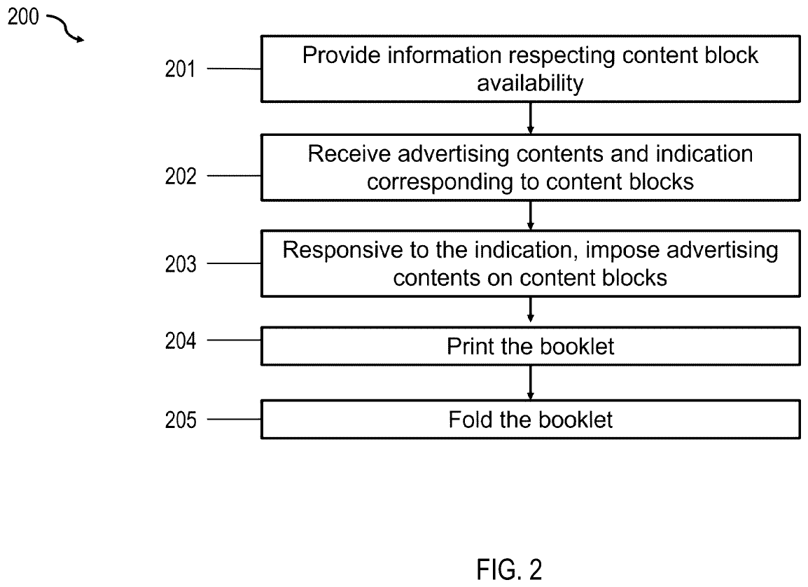

Referring now to FIG. 2, a method 200 of producing an exemplary advertising booklet according to the present disclosure is presented.

The method 200 comprises providing, to a plurality of advertisers, information respecting an availability of one or more content blocks (201). Each of the one or more content blocks may be associated with a predetermined publication date. Each predetermined publication date may have a predetermined quantity of content blocks available. Step 201 may be implemented on a variety of platforms. For example, step 201 may be implemented as a reservation system, wherein a user, such as an advertiser, may view the content blocks available for a predetermined publication date or for a range of publication dates. For example, a user may be provided with a zero availability on one publication date and with one or more available content blocks at a different publication date. It will be understood that step 201 may comprise providing availabilities on a predetermined publication date, or across a range of predetermined publication dates.

It will also be understood that step 201 may be performed simultaneously for a plurality of advertisers. Step 201 may also be implemented on a tiered or staggered basis. For example, a plurality of advertisers, such as members of a higher customer tier, for example an “Elite”, “Preferred”, “Gold” or other equivalent privileged tier, may be provided with an availability of content blocks at 201 while other advertisers belonging to other tiers are not provided with the availability. The tiered or staggered implementation may comprise time periods during which one or more advertisers are provided with the availability while other advertisers are not provided with the same availability or associating the availability of content blocks to the advertiser's tier. For example, “Preferred” advertisers may be provided with availability of content blocks more in advance of the predetermined publication date, for example between 1 and 12 weeks, 2 and 8 weeks, for example 6 weeks before the predetermined publication date. For example, “Preferred” advertisers may be provided with availability of content blocks situated on predetermined portions booklet, for example on one or more of the portions corresponding to “premium” pages, for example a back cover or an inside cover. It will be understood that one, two, three or more advertiser tiers may exist in implementations of the method 200 without departing from the principles disclosed herein.

The availability of the content blocks may be capped, for example at a predetermined number or quantity. The availability of the content blocks for each of the plurality of advertisers may also be capped at a predetermined number or quantity. For example, a predetermined publication date may have a predetermined quantity of content blocks associated with it, the number of content blocks corresponding to a final printed and folded booklet meeting predetermined mail delivery standards. Accordingly, the number of content blocks associated with a predetermined publication date may correspond to a number of sheets of printing substrate that, in combination, does not exceed a predetermined weight, for example 500 grams, or 250 grams, or 150 grams, or 100 grams.

The availability provided at 201 may be characterized by additional granularity. For example, the content blocks may be associated, in addition to a predetermined publication date, with a geographical area, such as a province, a State, a county, a region, a municipality, a township, a borough, a village, an arrondissement, a subdivision, a parish, a postcode, a neighborhood, or a letter carrier walk. For example, a small business, such as a local family-owned grocery store, may view the availability of content blocks associated with a local delivery area rather than availability across a larger municipality. For example, an advertiser may view availability associated with a particular municipality to target a promotion to residents of the municipality. For example, an advertiser may be provided with content block availability in a particular municipality or county for targeting a promotion, such as a discount, associated with opening a new location in the municipality or county.

Advertisers having been provided with the availability of content blocks at 201 may provide one or more advertising contents and may provide an indication corresponding to at least one of the content blocks (202). For example, an advertiser may choose a content block for a particular publication date and provide an advertising content to be displayed in the content block. For example, a grocery store may provide text, images or graphics, or other data, corresponding to a promotion and provide an indication of the content block the advertiser chooses among the content blocks provided as available at step 201. It will be understood that the advertiser may indicate a plurality of content blocks and provide one advertising content, for example an advertising content to be repeated a plurality of content blocks. An advertiser may also provide a plurality of advertising contents and provide indications corresponding to a plurality of content blocks, for example associating each advertising content to a content block. An advertiser may also provide an indication corresponding to a plurality of content blocks and a plurality of advertising contents, without associating each advertising content to a content block.

For each predetermined publication date, the advertising contents are imposed on the content blocks (203), responsive to the indications received at 202. It will be understood that the imposition may comprise paginating content blocks to fill the pages of the booklet, as well as rotating, flipping, reflecting, resizing and bleeding the advertising contents to produce the booklet.

The imposed content blocks may then be printed, for example by printing an advertising booklet comprising the content blocks (204). It will be understood that step 204 may be implemented by providing a print command to a printing equipment, for example a printing press, operatively connected to a system implementing the method 200, for example a computer system or a cloud solution. Accordingly, the method 200 may be implemented on a computer system comprising input/output means for communicating with a network, for example with the Internet, processing means for executing instructions for implementing the method 200 and storage means for storing data, such as content block availability data, data corresponding to advertiser indications and data corresponding to advertising contents. It will also be understood that step 204 may be implemented by providing data, for example across a network, to a different party, for example a commercial printer. The data may comprise the necessary information to print the booklet without further editing or processing.

The booklet is then folded (205) to a size conforming to a predetermined mail delivery standard. For example, the booklet may comprise one or more printed sheets and may be folded into quarters. Step 205 may be accomplished using a combined printing and folding device, or using a standalone folding device, or in another suitable way apparent to the skilled person.

The method 200 may further comprise providing the advertising contents to a user device. For example, the advertising contents may be provided in an application installed on a user device such as a smartphone, a smart watch, or others. It will be understood that the advertising contents may be processed, such as by resizing, flattening, compressing and otherwise adapted for displaying on user devices. The advertising contents may be provided to the user device via a communication network according to methods apparent to a skilled person.

The advertising contents provided to the user device may comprise additional advertising contents to those imposed on the content blocks at 203. For example, an advertiser may provide additional details with respect to an advertising content, or standalone advertising contents to supplement the advertising contents provided in the booklet, such as online-only offers, app-only coupons, and the like. The user device may be configured, for example through means of an application, to provide advanced navigation features including, but not limited to, interactive content, content responsive to QR or other printed codes, or contents adaptable to screen configurations and/or orientations. The advanced navigation features may be provided in a browser. It will be understood that the additional advertising contents may be provided using the same systems and methods used to implement step 202.

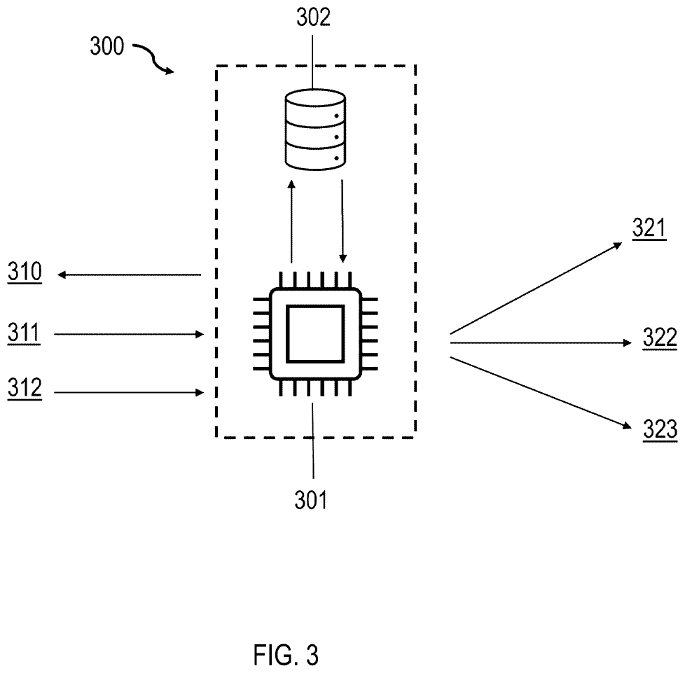

Referring now to FIG. 3, an advertising production management system 300 is presented. The system 300 comprises a processor 301 and a non-transitory storage medium 302 operatively connected to the processor. The non-transitory storage medium may store computer-readable instructions, such as a program. The processor 301, upon executing the computer-readable instructions, may be configured for implementing steps 201 to 203 described above, or similar steps for providing an availability 310 of content blocks associated with a predetermined publication date to a plurality of advertisers, receiving advertising contents 311 and indications 312 corresponding to content blocks from the advertisers and imposing or otherwise populating, paginating and/or arranging the content blocks for printing. The processor 301 is further configured to generate and output at least one of a soft proof 321, a print-related command 322 and a digital output 323 for receiving at a user device.

The soft proof 321 may be a soft proof for an advertising booklet comprising the content blocks associated with the predetermined publication date. The soft proof may be further communicated, for example to a computer configured to display the proof to an operator. Other uses of a soft proof will be apparent to a skilled person.

The print-related command 322 may be associated with the content blocks associated with the predetermined publication date. For example, the processor 301 may be configured to generate and output a print command to a printing press thereby printing the advertising booklet without further intervention, for example by an operator.

The processor may generate and output digital output data 323 that, when received at a user device, cause the user device to display the content blocks associated with the predetermined publication date. For example, the processor may generate and output data for displaying, in an application on a user device, the advertising contents associated with the publication date.

The non-transitory storage medium 302 may also comprise data associated with advertisers and/or with the advertising contents. For example, the storage medium 302 may store advertising contents 311 previously received from an advertiser and further store instructions for causing the advertiser to be prompted to repeat a submission, for example to repeat a certain advertising content 311 in a content block associated with a different publication date. For example, a grocery store advertiser may be prompted whether they wish to repeat an advertising content 311 received for a previous publication date in a content block associated with a future publication date.

The storage medium 302 may also comprise data corresponding to a cost for each content block. In such an implementation, the storage medium 302 may comprise instructions that cause the processor 301 to generate and output a payment request to an advertiser corresponding to the total cost of the content blocks corresponding to the indication received. The payment request may be an invoice, or another suitable payment request. For example, the system 300 may be configured to implement payment requests through an acceptable payment processing platform, for example PayPal™.

It will be understood that the system 300 or its components may be implemented on a physical machine, for example a computer comprising a processor and a memory, on a server, or as a cloud-based solution, for example as a cloud-based service with a web-based interface.

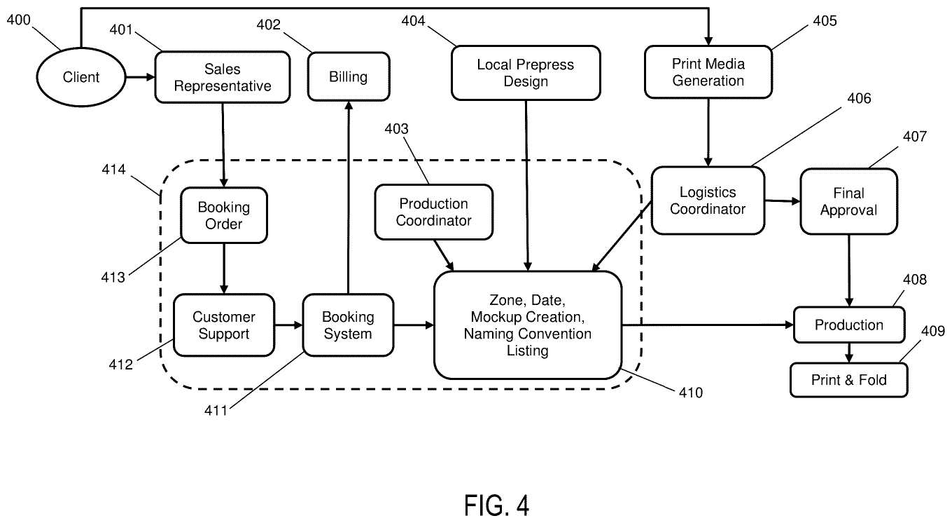

Referring now to FIG. 4, an exemplary workflow is illustrated showing functional blocks corresponding to one implementation of the systems and methods of the present disclosure. It should be noted that the workflow of FIG. 4 is a more detailed functional block implementation of the generalized methods steps shown in FIG. 2. In general, step 201 of the method includes functions 401, 412, and 413; step 202 includes function 410, step 203 includes function 403, 404, 405, and 410; and steps 204 and 205 generally include functions 408 and 409.

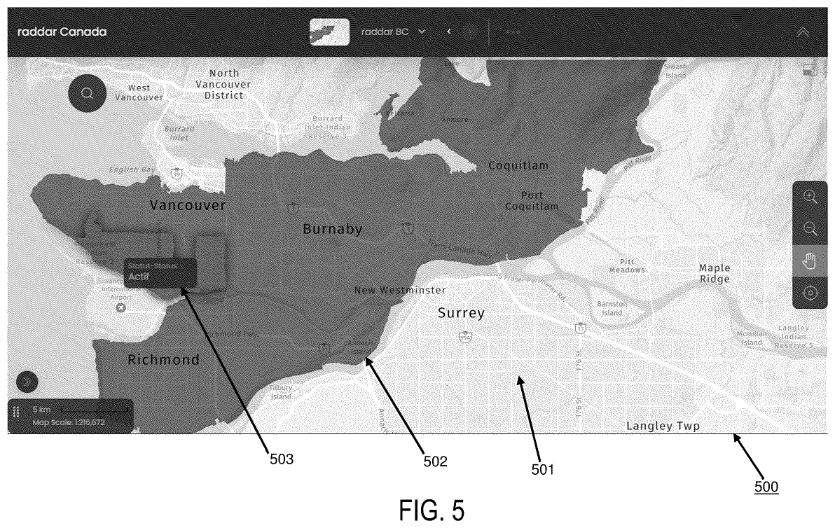

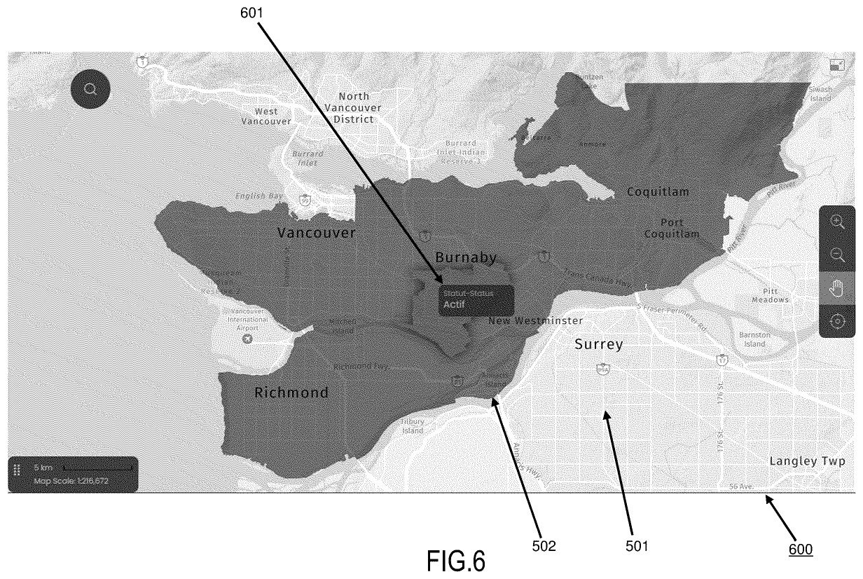

The functional workflow of the detailed implementation shown in FIG. 4 begins with engagement of the client 400. As previously mentioned, the present disclosure may be implemented with a web-based interface. As such, the client 400 engages with a graphical user interface (GUI) such as shown (and later described hereinbelow) with regard to FIGS. 5 and 6. The GUI may be via any device or devices such as, but not limited to, desktop or laptop computers, smartphones, tablets, or the like. It should be noted that the client is any entity or individual such as a retailer or other business, non-profit, or governmental interest that wishes to obtain advertising space in the printed advertising booklet which is an end product of the present systems and methods as previously discussed.

The client 400 engages with a sales representative 401. This may be direct engagement via a GUI or by any known sales mechanism such as telephone assistance. For example, the client 400 may interact directly with the system via their laptop computer or in addition to or alternatively via assistance from the sales representative 401 to thereby engage the system. Assistance may be telephonic, internet-based chat messaging, or any suitable interface. Indeed, the client 400 may independently navigate the GUI of the system such that the GUI itself functionally forms the sales representative 401 functional block. Once sales engagement is accomplished in the workflow, the core processing 414 occurs in terms of obtaining a booking order at functional block 413.

A booking order in accordance with the present disclosure should be understood to be a discrete advertising request from any given client. This may involve customer support shown at function block 412 which may or may not be required for the given client interaction. For example, an initial client interaction may involve more intervention and related assistance by customer support while a repeat client interaction may require little to no such intervention. Thus, functional block 412 may be considered optional for purposes of a returning client who then engages the booking system 411 as a returning client. It should be understood that returning clients may further be able to bypass the sales representative 401 as well as the customer support 412 so to directly engage a booking order 413 via the booking system 411. The booking system 411 includes elements such as elements relating to the specific client details and their respective account information (e.g., name, address, payment information, order history, etc.). Necessarily, the booking system 411 interacts with billing 402. Due to the nature of financial transactions, the billing 402 is illustrated outside the context of the core processing 414 whereby secure transactions are accomplished outside the context of the core processing 414 to ensure confidentiality of all financial transaction information. As should be understood, the billing 412 may be managed by third party financial transaction software as commonly understood in the web-based services field and therefore not further described herein.

As may be seen from FIG. 4, the client 400 includes a functional link to print media generation 405. This represents a separate stream in the workflow as client engagement from a core processing perspective differs from that of creating the specifics related to advertising artwork and corresponding text (as shown and previously described with regard to FIG. 1B). While some clients may provide some of their own print media artwork and text, others may rely upon a print media generation mechanism that may include centralized efforts shown by functional block 405 corresponding to print media generation. This may be accomplished by a third party whose function is to create the print media in accordance with client requirements. While this function is necessary to the overall functionality of the present system and method, print media generation 405 is well within the scope of those versed in the graphic arts and not further described herein. Client 400 interaction with print media generation may be adjunct to the system and method such that billing and client relations with print media generation 405 may be independent from the core processing in accordance with the present disclosure. This is particularly useful for high volume advertisers such as, but not limited to, large scale retailers at a regional or national level.

In contrast to high volume advertisers, there may also be a need for small scale advertising at a local level (e.g., city or county regions) for individuals or small enterprises. In such instances, an alternative print media generation mechanism may be local prepress design 404 provided to the client as an alternative to print media generation 405. Likewise, it is well within the contemplated disclosure that the capability of modifications to advertising copy provided by the client or provided by a third party (e.g., print media generation 405 or elsewhere) may be accomplished locally via local prepress design 404 on an ad hoc basis.

In coordination with a production coordinator 403 and logistics coordinator 406, the automated software engine 410 uses data derived from the booking system 411 and advertising copy derived from the print media generation 405 and/or the local prepress design 404 functions to accomplish a fully automated method based upon zones, timing in terms of dates and periods, mockup creation in terms of placement of advertising, and assurance of the overall look and feel of the advertising booklet including consistency in format, naming conventions, and naming conventions for all listings assembled into any given iteration of a specific advertising booklet.

The automated software engine 410 is further described with reference to the GUI interfaces 500 and 600, respectively shown in FIGS. 5 and 6. Both FIG. 5 and FIG. 6 are representations of an exemplary web interface showing zone selection in accordance with the present disclosure. In the most basic sense, the GUI interfaces 500, 600 represent geographic areas based upon the given market reach of the specific client. The client, themselves or through assistance by their sales representative and/or customer support would input data via a web-based questionnaire or pull-down menu to select a general geographic location. Depending upon the client market, this may include specific provinces or states (e.g., via one or more postal FSA segment(s), telephone area codes or exchanges, or the like) or regions (e.g., east of the Mississippi, New England states, Maritimes provinces, or the like).

In terms of the specific example illustrated in FIG. 5, there is shown a GUI interface indicative of one exemplary market in the Vancouver area of British Columbia. Here, the general market zone 502 available to a client based upon the client's inputted criteria (e.g., postal codes) is shown as highlighted by shading or colorization versus an unshaded or grayed-out unselected are 501. Within each general market zone 502, a client may then select a specific sub-zone 503 here indicated as a section of downtown Vancouver. In contrast, FIG. 6 shows a client selection of a specific sub-zone 601 here indicated as a section of lower Burnaby. These two zones may be chosen by the client as part of the initial booking order and processed by the booking system to enable the automated software engine 410 to place the client advertising into a group of additional clients with similar or overlapping zones. The automated software engine 410 may further consider variables such as, but not limited to, subject matter categories, competitor categories, naming conventions, timing constraints, and the like, in order to form a mockup of the sheet-by-sheet advertising that forms a given iteration of the advertising booklet.

It should be understood that the automated software engine 410 considers all client requirements and marketing data inputted into the booking system 411 to include the aforementioned variables to group symbiotic products and services while avoiding conflicting products and services from placement. This will automatically result in sections (i.e., a distinct set of sheets) being in business harmony, while additional sections may include a different general genre of advertising. By analogy, a typical newspaper includes sections related to sports, business, politics, comics, and the like. Likewise, the advertising booklet may comprise client advertising in one section dedicated to international food providers such as an Asian supermarket chain, ethnic restaurants and a local hardware store, while another section includes advertising for a more mainstream national supermarket chain and larger “box stores”. Likewise, some clients may book exclusively their own section of the advertising booklet.

While clients may be any retailer or service provider wishing to advertise, it should further be noted that the physical embodiment of the advertising booklet may include one or more sheets offered to one or more purveyors of news. In this manner, an otherwise incomplete compilation of advertising may be supplemented by one or more sheets including only news including text and/or images thereby completing a final mockup and subsequent assemblage of one or more sections. The news may be print media sourced from media outlets. Likewise, the news text and/or images may be in the form of local, regional, national, or international and may be customized in any manner by the production coordinator.

The combination of the final mockup for all sheets of advertising that comprise each section along with the assemblage of the given sections would be automatically created based upon the coordination of data received from the booking system considering the actual size and number of advertisements. The automated software engine 410 may accomplish this in any manner known in the programming art including, but not limited to, use of artificial intelligence. Once the automated software engine 410 indicates that the particular advertising window has been completely booked and all mockup activity is completed, the workflow will proceed to final approval 407 via the logistics coordinator 406.

Due to the highly automated nature of the system and method in accordance with the present disclosure, it should be noted in terms of the workflow of FIG. 4 that in practice, some embodiments of the present invention may be provided whereby the sales representative 401, customer support 412, production coordinator 403, and logistics coordinator 406 may be functions performed by a single individual. This highly automated nature therefore advantageously increases the overall effectiveness and efficiency of targeting advertising production.

Once final approval 407 occurs, the output of the automated software engine 410 is sent to production 408. As the output is digital in format, the system and method may be accomplished remote from the physical production facility. For example, a cloud-based embodiment of the present system and method may provide a digital work order to any number of production facilities strategically placed in any given geographic market. During production 408 tasks typical to the printing job order function will be accomplished such as press plate creation and final quality control common to printing of any paper-based product. The final step prior to distribution includes a print and fold 409 function to ensure consistent adherence of the advertising booklet to the constraints of the given mailing authority—i.e., size and weight standards for example imposed by Canada Post or the United States Postal Service (USPS). It should therefore be understood that while a specific size and shape is shown in FIG. 1A, other shapes and sizes along with end product mailing weight are possible though subject to production modifications for continued adherence to imposed mailing standards. Variables addressed during production 408 may therefore include variations in paper weight, density, finish, number of sheets, and number of sections without straying from the intended scope of the present invention.

In terms of size and weight constraints imposed for example by Canada Post, the final advertising booklet formed via the present method and system may vary depending upon the number of sheets provided to each section and therefore overall booklet of sections. However, it should be noted that the intended scope of the produced advertising booklet may be formation adhering to letter mailing requirements. Thus, the advertising booklet formed by the present method and system may be, in terms of USPS standards, a maximum thickness of 0.25 inch with a maximum length of 11.5 inches and maximum height of 6.125 inches and maximum weight of 3.5 ounces. Further, the advertising booklet formed by the present method and system may, in terms of Canada Post requirements, for standard lettermail include maximum dimensions of 245 mm×156 mm×5 mm (9.6 inches×6.1 inches×0.2 inches) and maximum weight of 50 grams, and for nonstandard lettermail include maximum dimensions of 380 mm×270 mm×20 mm (14.9 inches×10.6 inches×0.8 inches) and maximum weight of 500 grams.

The systems and methods disclosed herein provide advantages over existing advertising systems and methods. Integrating advertising contents from a plurality of advertisers reduces clutter, reduces resource consumption, including paper consumption, and improves the efficiency of content distribution by providing a convenient format for mail distribution to a plurality of households. The production methods and systems disclosed herein reduce production time by reducing the need for operator or editorial intervention. Digital integration methods disclosed herein allow for advertisers to target customers with both print and digital content, allowing advertiser-side customization of the consumer experience and enabling interactive and flexible advertising delivery responsive to the needs of the advertiser.

The embodiments described above are intended to be exemplary only. Various modifications to the illustrated embodiments will be readily apparent to those skilled in the art, and the generic principles disclosed herein may be applied to other embodiments and applications without departing from the present teachings.

1. An admail advertising system including content from a plurality of clients, the system comprising:
a plurality of stacked sheets of printing substrate, the sheets of printing substrate including one or more fold lines and being configured to fold along the fold lines;
printed indicia on the one or more sheets, the printed indicia corresponding to one or more content blocks, each content block being associated with one client;
wherein the system weighs 200 grams or less and wherein the system, when folded, include maximum dimensions of 245 mm×156 mm×5 mm.

2. The system according to claim 1, wherein the system is configured to be folded in quarters.

3. The system according to claim 2, wherein at least one of the plurality of clients is selected from the group consisting of retailers and news outlets.

4. The system according to claim 2, wherein the system is an unaddressed admail system.

5. The system according to claim 2, wherein the system is an addressed admail system.

6. The system according to claim 2, wherein the system weight 150 grams or less.

7. A method of producing an advertising booklet compatible with letter carrier delivery, the booklet comprising a plurality of advertising contents from a plurality of advertisers, the method comprising:
providing to the plurality of advertisers information respecting an availability of one or more content blocks, each of the one or more content blocks being associated with a predetermined publication date, each predetermined publication date having a predetermined quantity of content blocks available;
receiving, from two or more of the plurality of advertisers:
from each advertiser, at least one of the plurality of advertising contents,
from each advertiser, an indication corresponding to at least one of the plurality of the content blocks;
responsive to the indications received from the plurality of advertisers, imposing the advertising contents on content blocks associated with the predetermined publication date;
printing the advertising booklet comprising the content blocks so imposed;
folding the advertising booklet to a size conforming to maximum dimensions of 245 mm×156 mm×5 mm.

8. The method according to claim 7, wherein the availability of the one or more content blocks for each of the plurality of advertisers is capped at a predetermined number.

9. The method according to claim 8, wherein each of the one or more content blocks is further associated with a geographic area.

10. The method according to claim 9, wherein the geographic area is a municipality.

11. The method according to claim 9, wherein the geographic area is a postcode segment.

12. The method according to claim 9, wherein the geographic area is a letter carrier walk.

13. The method according to claim 9, further comprising providing the content blocks comprising the advertising contents to a user device.

14. The method according to claim 13, further comprising receiving additional advertising contents from the plurality of advertisers and providing said additional advertising contents to the user device.

15. An advertising production management system comprising:
a processor;
a non-transitory storage medium operatively connected to the processor, the non-transitory storage medium comprising computer-readable instructions;
wherein the processor, upon executing the computer-readable instructions, is configured for:
providing to a plurality of advertisers information respecting an availability of one or more content blocks, each of the one or more content blocks being associated with a predetermined publication date, each predetermined publication date having a predetermined quantity of content blocks available;
receiving, from two or more of the plurality of advertisers:
from each advertiser, at least one advertising content; and
from each advertiser, an indication corresponding to at least one of the plurality of the content blocks;
responsive to the indications received from the plurality of advertisers, imposing the advertising contents on content blocks associated with the predetermined publication date;
generating and outputting one of:
a soft proof for an advertising booklet comprising the content blocks associated with the predetermined publication date;
a print-related command associated with the content blocks associated with the predetermined publication date; and
digital output data that, when received at a user device, cause the user device to display the content blocks associated with the predetermined publication date.

16. An advertising production management system including a processor and a non-transitory storage medium operatively connected to the processor and including computer-readable instructions, the system, upon the processor executing the computer-readable instructions, comprising:
a booking system for generating an order from a client, the order including client advertising data and zone preference collection;
a media generation mechanism for providing print media corresponding to client advertising;
an automated software engine for correlating client advertising data and zone preferences received from the client and at least one additional client to produce a digital output corresponding to an advertising booklet; and
a production facility for printing and folding a physical embodiment of the advertising booklet.

17. The system as claimed in claim 16 wherein the media generation mechanism includes large scale media generation.

18. The system as claimed in claim 16 wherein the media generation mechanism includes local prepress design.

19. The system as claimed in claim 16 wherein the booking system includes a graphical user interface for client selection of zone preferences corresponding to client advertising markets.

20. The system as claimed in claim 16 wherein the physical embodiment of the advertising booklet includes advertisements of the client and the at least one additional client and is sized and dimensioned in a folded state to adhere to postal mailing constraints.
